(19) United States
(12) Patent Application Publication
(10) Pub. No.: US 2006/0037184 A1
(43) Pub. Date: Feb. 23, 2006

(54) Socket driver

(76) Inventor: Jerry Miller, Parksville (CA)

Correspondence Address: VERMETTE & CO., BOX 40, GRANVILLE SQUARE, SUITE 230 - 200 GRANVILLE STREET, VANCOUVER, BC, V6C 1S4, CA

(21) Appl. No.: 10/921,101

(22) Filed: Aug. 19, 2004

(51) Int. Cl. B25B 27/14

(52) U.S. Cl. 29/275

(57) ABSTRACT

A socket driver for installation and removal of bearings, bushings, and damaged nuts and bolts. The socket driver has a driving end, a body, a flange and a square bit. The body joins the driving end and the flange. The square bit is at the end of the socket driver opposite the driving end and adjacent the flange. In use, the driving end of the socket driver receives a driving force, usually in the form of hammer blows. The flange operates to distribute the driving force evenly to the surface of a socket, from a socket or ratchet set, thereby preventing damage thereto.

### FIELD OF THE INVENTIONS

This invention relates to a socket driving tool, having application in the installation and removal of bearings, bushings and damaged nuts and bolts.

### BACKGROUND OF THE INVENTION

Mechanics are often required to remove or insert bearings and bushings as part of their work. Often, it is not possible or desirable to apply force directly to the bearing or bushing using a hammer or other tool because the bearing or bushing will be damaged. Force must be applied carefully and evenly to avoid such damage. In the case of a bearing being installed in a bore with an interference fit on the outer race, installation force should be applied evenly to the outer race. Applying force to inner race can damage the bearing. If brass bushings are being installed in a bore, striking them with a hammer will surely damage them. It is often difficult to apply such forces evenly to bearings and bushings because they are not easily accessible. For example, if bearings are installed in a deep bore they are not accessible to a hammer or a press having a shaft that is larger than the outer race.

For these and other reasons there have been developed many specialized bearing and bushing installation tools, such as those disclosed by U.S. Pat. Nos. 3,083,347; 3,266,347; 3,942,234; 4,050,136; 4,339,865; 4,429,447; 6,098,261; and 6,446,328. However, such tools are specialized for a unique application and, therefore, tend to be costly and are not readily commercially available. Due to the cost, availability, and even to the amount of space taken up by such specialized tools in a tool set, they are not readily available to the home handyman, field service mechanics and the technicians working in remote locations.

Accordingly, many mechanics have improvised by using standard sockets, normally used to remove or install bolts, to install bearings or bushings. Most mechanics and handymen have socket or ratchet set having a wide selection of sockets ranging for ¼″ drive with an outside diameter of 5/16″ to a 1″ drive with an outside diameter of 4″. With this range of sizes the mechanics can usually find a socket that will fit the bearing or bushing with which they are working.

When using a socket for bearing or bushing installation the socket is usually struck with a hammer to force the bearing or bushing into its bore or housing. This frequently damages the square hole on the socket that accepts the square bit of the ratchet or extension. If an extension is used to drive the socket into deeper holes, and it is struck with a hammer, the tapered section of the extension can be jammed in the socket. The drive end of the extension (i.e. the end that is meant to accept the square bit of a ratchet) is also damaged by the hammer blows. In other words, ratchet and socket sets are not intended for use as bearing installation tools and, when used for such applications, they are damaged to the point where they eventually become unusable for their original intended application, namely, loosening and tightening nuts and bolts.

In addition, bolts and nuts that hold ground-engaging equipment, such as loader bucket teeth, bulldozer and grader cutting edges and track pads, become damaged by contact with the earth. Such damage often makes it necessary to force the sockets onto the nuts or bolt heads in order to remove them. Obviously, the sockets are most easily forced onto the nuts or bolts by striking them with a hammer, resulting in damage to the sockets themselves.

Accordingly, it is an object of the present invention to provide an improved tool for the installation or removal of bearings, bushings, and damaged nuts and bolts. It is a further object of the present invention to provide a tool that prevents damage to sockets used to install or remove bearings, bushings, and damaged nuts and bolts.

### SUMMARY OF THE INVENTION

The present invention is a socket driver for installation and removal of bearings, bushings, and damaged nuts and bolts using conventional sockets from a socket or ratchet set. The socket driver has a driving end, a body, a flange and a square bit. The body joins the driving end and the flange. The square bit is at the end of the socket driver opposite the driving end and adjacent to the flange.

To install or remove a bearing or bushing a socket of appropriate size is selected from a socket set. The socket must contact the bearing or bushing in such a way that forces applied to the socket will be evenly distributed to the bearing or bushing so as not to damage it. When the socket driver is in use the square bit engages the drive hole of the socket to maintain the socket driver and socket in constant position relative to one another. The driving end receives a driving force, usually in the form of hammer blows, and the flange operates to distribute the driving force evenly to the surface of the socket so as to prevent damage thereto.

Similarly, in order to remove or install a damaged nut or bolt, a socket is first chosen that best fits the nut or bolt. The square bit of the socket driver then engages the drive hole of the socket to maintain the socket driver and socket in constant position relative to one another. The driving end of the socket driver receives a driving force, usually in the form of hammer blows, and the flange operates to distribute the driving force evenly to the surface of the socket so as to prevent damage thereto. Once the socket is securely placed over the nut or bolt, the socket driver is removed and the socket is turned using a convention ratchet.

In a preferred embodiment the square bit has a spring loaded ball bearing which is operative to engage the inner surface of the drive hole of the socket so as to hold the socket driver and socket together by friction.

### BRIEF DESCRIPTION OF THE DRAWINGS

Further features and advantages will be apparent from the following detailed description, given by way of example, of a preferred embodiment taken in conjunction with the accompanying drawings, wherein:

FIGS. 1(a) and (b) are top and side cutaway views of a prior art socket, respectively;

FIG. 2(a) is a side cutaway of a prior art socket and extension;

FIGS. 2(b) and (c) are end views of the drive and tapered ends of a socket extension, respectively;

FIG. 3 is a side cutaway view of a prior art socket when used to apply force to the outer race of a bearing;

FIG. 4 is a side cutaway view of the driver of the present invention engaged with a socket and driving a bushing;

FIG. 5(a) is a side cutaway of the socket driver of the present invention;

FIGS. 5(b) and (c) are end views of the drive and tapered ends of a socket driver of the present invention, respectively; and

FIG. 6 is a ¾ exploded view of a socket driver, socket and bushing.

### DETAILED DESCRIPTION OF THE INVENTION

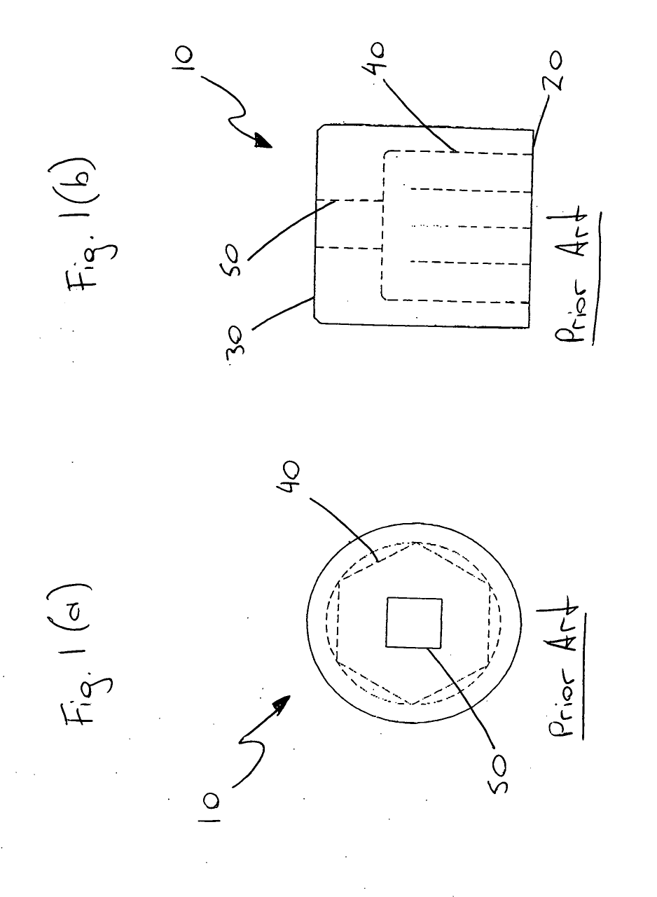

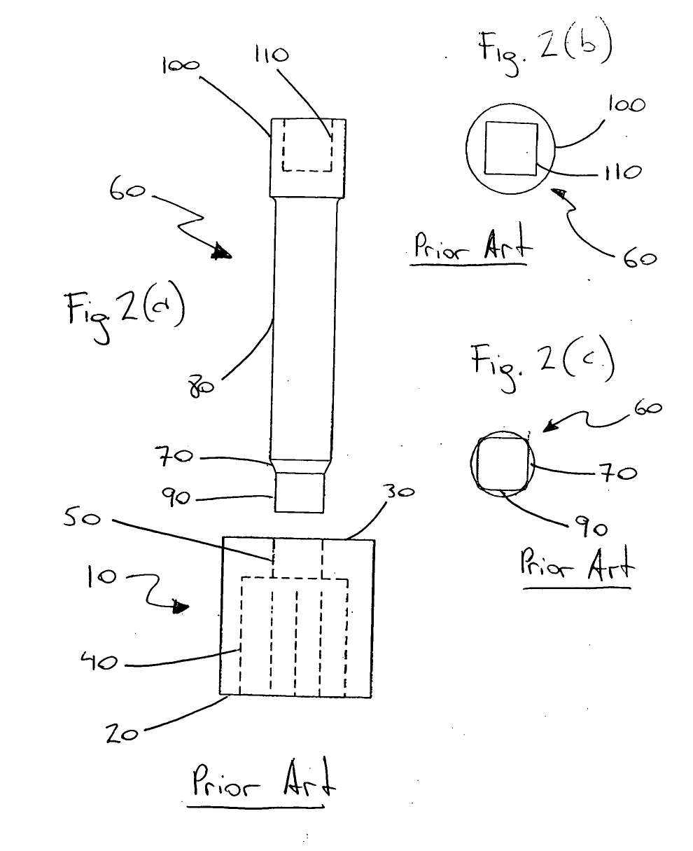

Referring to FIGS. 1(a) and (b), a prior art socket 10 is shown having a socket end 20 and a drive end 30. The socket 10 has a hole 40 in the socket end 20 for receiving nuts and bolts and a drive hole 50 in the drive end 30 for receiving the square bit of a ratchet (not shown) or extension (see FIG. 2(a)).

Referring to FIGS. 2(a-c), a prior art socket 10 and extension 60 are shown. The socket 10 has a hole 40 for receiving nuts and bolts and a drive hole 50 for receiving the square bit 90 of the extension 60 (or the square bit of a ratchet). The extension 60 has a tapered section 70 between the body 80 and square bit 90, and a drive end 100 having a drive hole 110 for receiving the square bit of a ratchet (not shown).

Referring to FIGS. 1(a-b) and 2(a-c), when used in its intended application, a socket 10 of appropriate size is selected so that a nut or bolt is fittingly received by the hole 40. The square bit of a ratchet (or extension 60) is inserted into the drive hole 50 and torque applied thereto in order to tighten or loosen the nut/bolt.

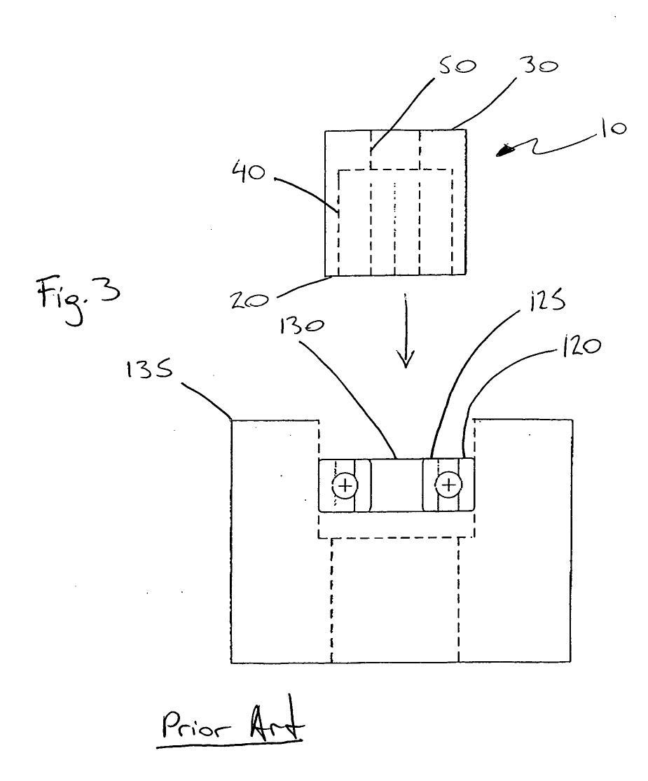

Referring to FIG. 3, a socket 10 is shown being used to apply a driving force to the outer race 120 of a bearing 130 to drive the bearing 130 into a housing 135. The bearing 130 additionally has an inner brace 125. The socket 10 is placed such that the edge forming the circumference of the hole 40 at the socket end 20 is in contact with the outer race 120 of the bearing 130. A force is then applied to the drive end 30 of the socket 10, usually with a hammer. Alternatively, referring to FIGS. 2(a) and 3, an extension 60 can be used and a force applied to the drive end 100 of the extension 60, thereby driving the socket 10 and bearing 130. Hammer blows to the socket 10 damage the square drive hole 50 of the socket 10, making it difficult or impossible to insert the square bit of a ratchet or extension 60. Hammer blows to the drive end 100 of the extension 60 will damage the square drive hole 110 of the extension 60, making difficult or impossible to insert the square bit of a ratchet. In addition, applying such a force to the drive end 100 of the extension 60 jams the tapered section 70 against the edges of the drive hole 50 in the socket 10, causing further damage to the extension 60 and socket 10.

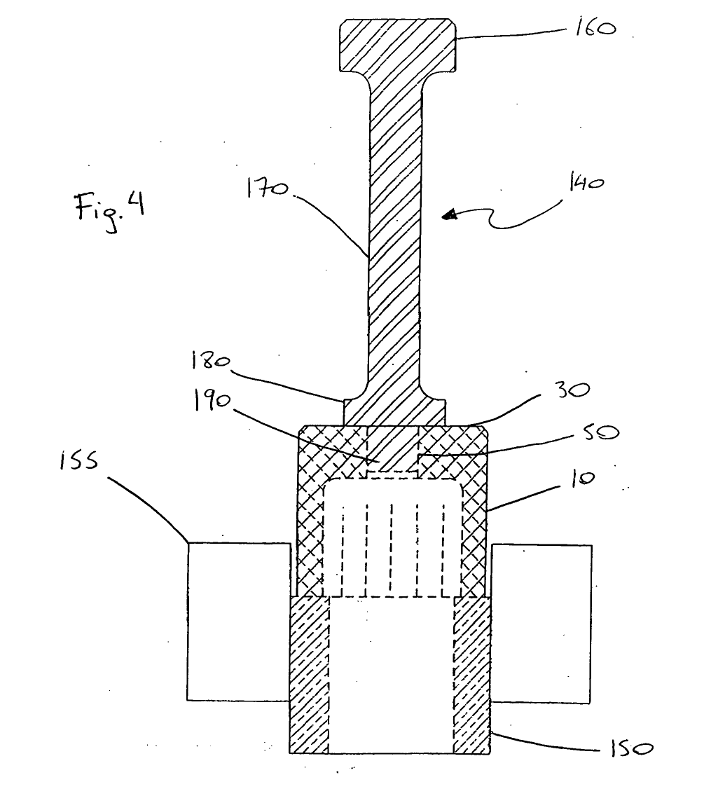

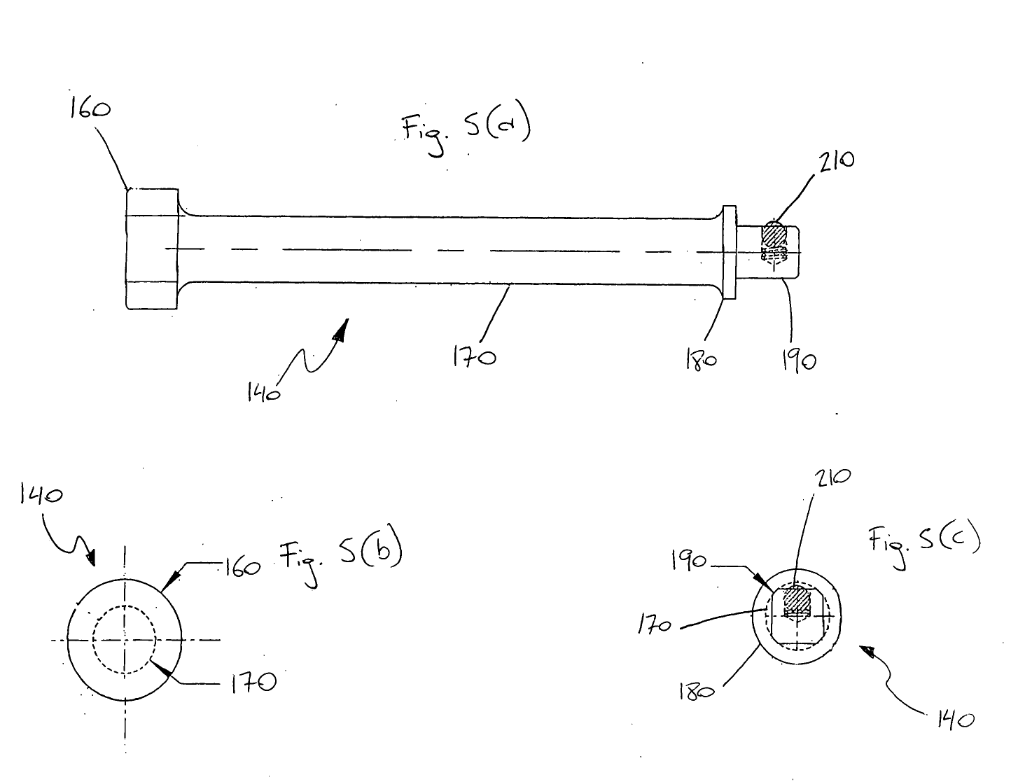

Referring to FIGS. 4, 5(a-c) and 6, the socket driver 140 of the present invention is shown, which allows the use of sockets 10 to drive bearings 130 (see FIG. 3) or bushings 150 while preventing damage to the sockets 10 and extensions 60 (see FIG. 2(a)). The socket driver 140 has a driving end 160, a body 170, a flange 180 and a square end 190. The driving end 160 has a driving head that receives the force, usually in the form of hammer blows, for driving the socket driver 140, socket 10 and bushing 150. By applying force to the socket driver 140, the bushing 150 is driven from housing 155. The flange 180 distributes the force from the hammer blows evenly to the drive end 30 of the socket 10. The even distribution of the force prevents damage to the socket 10. Damage to the extension 60 (see FIG. 2(a)) is also avoided because it need not be used. The square end 190 of the socket driver 140 is fittingly received by the drive hole 50 of the socket 10. In the preferred embodiment the square end 190 of the driver 140 has a spring loaded bearing 210 which engages the side of the drive hole 50 of the socket 10 and keeps the driver 140 in place.

By evenly distributing and transferring forces to the socket 10, the socket driver 140 prevents damage to the socket 10. By preventing damage to the socket 10 and extension 60 the socket driver tool 140 allows for the use of a socket set as a bearing and bushing installation kit. With the addition of the socket driver 140 to a tool set, mechanics can make use of a socket set, which forms an essential part of virtually every tool set, to drive and install bearings 130 and bushings 150, rather than purchasing specialized tools having limited application.

Although referred to as a “square” end 190, the square end may have any shape that allows it to effectively engage a socket and maintain the socket driver and socket in constant relative position while a driving force is applied to the socket driver. It is a generally accepted industry standard that the socket driving holes are square in shape. Therefore, the preferred embodiment of the present invention has been described accordingly.

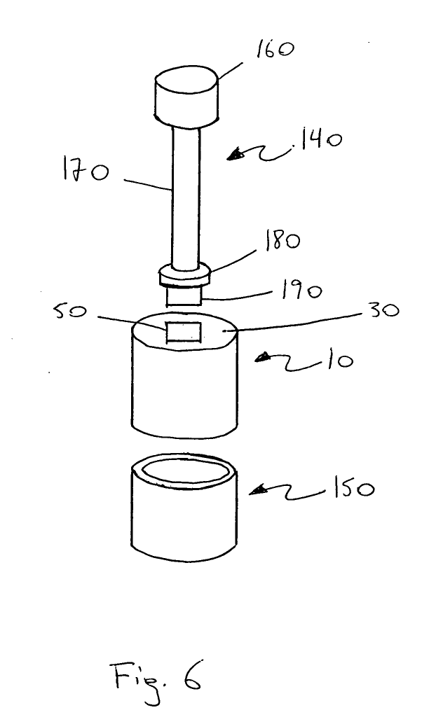

Although not shown in the Figures, it is clear from the above discussion that the socket driver can also be used to install and remove damaged nuts and bolts. When the socket driver is used for such an application, the socket driver 140 engages the socket 10 in the same manner as depicted in FIGS. 4-6. First a socket of appropriate size is selected and the square bit 190 of the socket driver 140 engages the drive hole 50 of the socket 10. The socket is then positioned adjacent the nut or bolt such that the hole 40 of the socket is capable of receiving the nut or bolt. The driving end 160 of the socket driver then receives a driving force, usually in the form of hammer blows, and the flange 180 operates to distribute the driving force evenly to the surface of the socket 10 so as to prevent damage thereto. Once the socket has been driven onto the nut or bolt, the socket driver is disengaged from the socket and a ratchet or impact wrench engaged therewith. The ratchet or impact wrench is then used to turn the nut or bolt.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

1. A tool for driving a socket, comprising:
a) a driving end operative to receive a driving force;
b) a flange;
c) a body connecting said driving end to said flange; and
d) a square end adjacent said flange and operative to engage a drive hole of a socket;
wherein said flange is operative to contact a surface of said socket when said square end engages said drive hole and wherein said flange is operative to distribute said driving force to said surface.

2. The tool of claim 1, wherein said square end includes a spring loaded bearing operative to engage a side of said drive hole.

3. The tool of claim 1, wherein said driving end forms an enlarged driving head operative to receive hammer blows.

4. A tool for installing and removing bearings, bushings, and nuts and bolts, said tool for use in combination with a socket from a conventional socket set, said socket having a drive end and a socket end, said drive end having a drive hole and said socket end having a hole for receiving nuts and bolts, said tool comprising:
a) a driving end operative to receive a driving force;
b) a flange;
c) a body connecting said driving end to said flange; and
d) a square end adjacent said flange and operative to engage the drive hole of the socket;
wherein said flange is operative to contact the drive end of the socket when said square end engages the drive hole and wherein said flange is operative to distribute said driving force to the drive end of the socket.

5. The tool of claim 4, wherein said square end includes a spring loaded bearing operative to engage a side of the drive hole.

6. The tool of claim 4, wherein said driving end forms an enlarged driving head operative to receive hammer blows.
